(19) United States
(12) Patent Application Publication
(10) Pub. No.: US 2007/0072150 A1
(43) Pub. Date: Mar. 29, 2007

(54) High-strength dental-implant w/cone-locking & swaging abutment

(76) Inventors: Robert F. Mansueto, Coronado, CA (US); Robert W. VonHeck, San Diego, CA (US)

Correspondence Address: Pillsbury Winthrop LLP;Intellectual Property Group, Suite 200, 11682 El Camino Real, San Diego, CA, 92130, US

(21) Appl. No.: 10/046,000

(22) Filed: Oct. 27, 2001

Related U.S. Application Data
(60) Provisional application No. 60/243,676, filed on Oct. 26, 2000.

(51) Int. Cl. A61C 8/00

(52) U.S. Cl. 433/174

(57) ABSTRACT

An endosseous dental-implant apparatus of enhanced strength structure, UniPlant™ is set forth in gineric-variant embodiments providing optional positive indexing engagement between the primary-implant stanchion and the adjoining abutment-post;—one iteration employing an abaxial Keypin™, the other employing an asymmetrical abaxial or oppositely symmetrical TorqueLug™ indexing device. Both these embodiments serving to obviate structural-failure problems occuring with some commercially available dental-implants. Other advancements to the science of dental-implantation are a special HyperSwage™ provision which assures an intimately imperforate perimeter-joint seam between the primary-implant and its abutment-post member; plus, an enhanced TruLock™ vertically engaging dual-cone arrangement between the primary-implant and its abutment-post. With these two joining features optionally combined, the structural-integrity of the dental-implant constitutes the utmost in lasting quality. Additionally, the primary-implant features an optional NRB™ (negative/reverse-buttress) screw-thread configuration, providing greater resistance to compressive-forces, and thereby extending the osseointegration life-expectancy of the prosthesis.

### BACKGROUND OF THE INVENTION

1. Field of Invention

This invention relates to endosseous type screw-threaded dental-implants for osseointegration; and more specifically it relates to dental-implants employing a screw together primary-implant and abutment-post structures, as well as construction devised to obtain anti-rotational and imperforate joining of these two structural members; plus, disclosure relates to systemic tool methods by which these elements install in recepient.

2. Relevant Prior-Art

Background research discovery provides some prior patent-art regarded as germane to this disclosure, chronologically for example in early U.S. Pat. No. 943,113 (filed: February 1909) is adapted with a slide-on abutment-crown mounting for insertion into recipient's alveolus: while materials such as gold, silver, platinum, porcelain were proposed, it is believed the structure was prone to gathering bacteria, thereby causing adverse sepsis and necrosis, and so fell into disfavor.

In U.S. Pat. No. 2,112,007 (filed January 1937) is shown a dental-implant device comprising a primary-implant member having enternal screw-threads and at the lower-terminus and initial drainage-passages leading into a central-shaft having female/screw-threads; whereby a screw-threaded rod was subsequently inserted with sufficient screw-threads extending above the implant for attachment of an abutment-post preferably having a ball shaped upper-terminus; thereby providing anchoring for recipient's prosthetic-teeth or a bridge. However, the radial perimeter-shoulder of the implant lacked an exceptionally imperforate perimeter joint-seam by which to resist potential formation of bacterial infection.

In U.S. Pat. No. 2,347,567 (filed: March 1943) is shown a dental-implant wherein is taught the use of a non-metallic thermoplastic/methyl-methacrylate material said not to create adverse electrolytic-action; plus, the primary-implant was provided with two or more abaxially opposed indexing-holes (13) by which a a pair of vertically registering bifurcated-prongs (15) extending from a so-called screw-driver like delivery-tool (14) would enable the dentist to better manipulate the new primary-implant during installation.

In U.S. Pat. No. 3,732,621 (filed: March 1971 from Sweden) is shown a primary-implant having an abutment-post featuring a ball&socket arrangement serving to facilitate installation into a recipient's alveolar-bone in places where an angled-entry is required.

In U.S. Pat. No. 4,468,200 (filed: November 1983 from Germany) is shown a primary-implant member having positive-butress type external/screw-threads and a longitudinal concentric quad-shaped shaft into which is inserted and cemented the lower-shank of an abutment-post; however, it has no provision for preventing the growth of bacteria at the joint between the abutment-post and the radial upper-terminus of the primary-implant.

In U.S. Pat. No. 4,488,875 (filed: October 1983 by G. A. Niznick-dds) is shown a primary-implant having an improved ball&socket snap-on arrangement for an overdenture.

In U.S. Pat. No. 4,626,214 filed: May 1984 from Spain) is shown a primary-implant featuring positive-butress external screw-threads and a female/screw-threaded central longitudinal shaft into which was installed a partially screw-threaded shank portion of an abutment-post, and whereto are employed transverse O-ring type seals by which to attain a resilient barrier to passage of bacteria;—unfortunately, the seals have proven to not address the potential accumulation of bacteria proximal the critical perimeter joint prevailing between the primary-implant's radial-shoulder and the mating radial surface of the abutment-prosthesis.

In U.S. Pat. No. 4,645,453 (filed: September 1985 by G. A. Niznick) is shown an primary-implant body having a myriad of transverse venting-holes apparently for promotion bonding with recipient's alveolar-bone; and primarily sets forth the notion of a bendable-adapter shank in support of an abutment-post.

In U.S. Pat. No. 4,713,004 (filed: September 1986) is shown a primary-implant adapted with an intermediate-abutment which can be canted to desired degree of angularity; including ball&socket as well as fixed-pitch iterations are revealed.

In U.S. Pat. No. 4,960,381 (filed: August 1988 by G. A. Niznick) is shown a very popular CoreVent-corp. embodiment for a primary-implant, featuring a countersunk internal-hex provision;—which although regarded as successful is prone to certain problems that this instant disclosure purports to overcome; as is discussed later herein.

In U.S. Pat. No. 5,433,606 (filed: September 1993 by G. A. Niznick) is shown another CorVent primary-implant embodiment, here setting forth an upwardly extending wrenching-hex in contrast to the inventor's preceding configuration; but otherwise functions in a similar manner.

In U.S. Pat. No. 5,449,291 (filed: December 1993 via Calcitek-corp.) is shown a primary-implant device which includes an abutment-post having a plurality of radially disposed splines which impinge upon mating splines arranged around the upper-terminus of the primary-implant, so as to thereby enable the dentist to select one of to the positions for positive indexing of the abutment.

In U.S. Pat. No. 5,885,079 (filed: June 1998 by G. A. Niznick of CorVent-corp.) is shown a primary-implant device which is a modification of the inventor's earlier U.S. Pat No. . . . 381 (above), wherein effort is made to improve strength problems (ie:—stripping of the allen-wrench engaging surfaces in the presense of hi-density alveolar-bone); plus, the patent addresses various surface-treatments and coatings by which to improve osseointegration of the implant.

In U.S. Pat. No. 5,967,783 (filed: October 1998) is shown a primary-implant setting forth various improvements, including a special alternatingly staggered (called: interleaved) endosseous screw-thread said to promote more rapid osseointegration with recipient's alveolar-bone.

In U.S. Pat. No. 6,102,703 (filed: February 1999 by Suizer-Calcitek Corp.) is shown a primary-implant for dental endosseous, wherein is addressed the surface treating and coating of a bio-reactive plasma-sprayed coating identified as preferably HA/hydroxlapatite (calcium-carbonate, sodium-bicarbonate, or partially-crystalline HA-material).

In U.S. Pat. No. 6,149,432 (filed: January 1999) is set forth a particular butress/screw-thread which is splayed toward the recipient's alveolar-bone, however there is no anticipation of actually employing a negative-undercut to the thread cross-section.

In U.S. Pat. No. 6,183,255 (filed: March 2000) is shown a dental/primary-implant wherein is employed an externally accessible vertical abutment-post retainer-screw arrangement; although the disclosure primarily sets forth the surface is treated with a rutile-crystalline substance tied to HA for example.

In U.S. Pat. No. 6,273,722 (filed: November 1999) is shown a special hybrid cross-threaded (ie: employing a crossover of both left-hand and right-hand screw-threads), wherein one screw-thread is formed conventionally, while the crossover screw-thread is formed in the manner of an opposite spiral-groove; the combination said to enhance long-term osseointegration.

In U.S. Pat. No. 6,287,117 (filed: April 1999 by G. A. Niznick to SuizerCalcitek-Dental Co., who have recently acquired CorVent's pat.-portfolio) is shown a further improvement to the inventors U.S. Pat. Nos. . . . 381 & . . . 606 (see above), and particularly addresses various iterations of subtle abutment-post refinements.

The mentioned U.S. Pat. No. 4,960,381 by CoreVent® Inc. became a well known device for endosseous via an external self-tapping male/screw-threaded (or helical) type primary dental-implant portion (anchor) which is set forth with generic-variant embodiments, wherein both a shallow-inset upper female/wrenching-surface (above the internal screw-threads for an abutment-post) and an optional deeply-inset (below the screw-threads) female/wrenching-surface is featured. Additionally, a transversely and longitudinally vented distal-terminus is incorporated (a feature now regarded as not being particularly effective by many dental-implant practitioners); thus the upper internal wrenching-surfaces (of the version available commercially) tends to be necessarily shallow owing to the longitudinal space occupied by the distal-terminus venting construction, thus is prone to stripping out of registration with its hexagonal (Allen type) wrench cross-section when entering harder bone. Moreover, the six internal 120-degree angulations of the wrenching-surface introduce concentrated stress-load moments-of-force, which configuration tends to structurally weaken the overall implant sidewall, even though of high-grade titanium (subject to 2,500-psi. biting-loads,—which can thus equate to concentrated specific-loadings of some 100,000-psi. in these failure prone sidewall angulations). The outermost head-portion includes a deep smooth bore opening out contiguously with an uppermost large 45-degree (shown) annular-chamfering contiguous to a slight 30-degree (not identified as having any function other than possibly machine-deburing) perimeter-beveling formed contiguously with the smooth external head's vertical sidewall. The larger inset (45-degree) annular-chamfer is adapted to provide a smooth supporting surface upon which inserts (such as an abutment-post for a prosthetic-tooth) engage upon. The cooperative abutment-post provided by CoreVent® for use with their primary implant anchor, employs a typical frustrum (conical with a flat top) shaped mounting-post, which the mentioned wrenching-surface of the primary implant, thereby well preventing inadvertent rotation of the abutment-post (hence undesired rotation of the finally cemented-on prostheses. A tiny sacrificial cinching-screw is installed down centrally through the abutment-post and into the primary implant's internal screw-threads, thereby positively holding the primary and secondary implant members together. However, the wrenching-tool provided by CoreVent® to initially torque the primary-implant into its pilot-hole, is of entirely different size than the smaller allen-tool they provide to subsequently torque the secondary member in place;—which combined with the tiny screw, become more part pieces for an already technically burdened implant-dentist to contend with.

Therefore, in full consideration of the preceding patent review, there is determined need for a simplified form of improved device to which these patents have been largely addressed. The instant inventors hereof believe their newly improved dental-implant apparatus, commercially referred to as the UNI-PLANT™ system featuring the TRU-LOCK ABUTMENT™, currently being developed for production under auspices of ICA/Implant-Centers of America™,—Mfg./Mkt.Co.,—exhibits certain advantages as shall be revealed in the subsequent portion of this instant disclosure.

### SUMMARY OF THE INVENTION

A.) In view of the foregoing discussion about the earlier invention art, it is therefore important to make it pellucid to others interested in the art, that an object of this invention is to provide a substantially simplified (thus, of lower intrinsic-cost, hence more affordable) one-piece endoessous type externally anchoring primary-implant device, and attendant support system components. While the primary-implant hereof can generally employ any type of external male/screw-thread, we preferably employ screw-threads of the reverse-buttress type, and still more preferably of a novel “undercut” negative/reverse-buttress configuration, which especially in the case of the latter is uniquely able to afford maximum bite-load support-area shore bracing, owing to the screw-threads extreme bias toward recepient's alveolar-bone (either maxillary or mandibular arch), thereby lending superior resistance to biting compression-loads (which is of particular importance to those installations where the recipient's maxillary and mandibular bone-composition density is characterized as marginal). Note here, that presently many commercial primary-implants employ external screw-threads of a positive-buttress type (ie:—biased away from lower-terminus of the primary-implant), hence thought by some to provide greater resistance of the primary-implant becoming dislodged from alveolar-bone. Others have simply been proponents of a moderate balanced screw-thread/pitch (having positive underside dihedral), or at most a reverse-buttress type screw-thread (having horizontal underside portion);—accordingly, we present our unique extreme bias configuration (optionally ranging approximately 1-to-30-degrees underside neg.-diehedral) as providing superior shoring-up or “shore-stabilized” screw-thread surface-area having an actual umbrella-like negative-dihedral pitch at the underside of the reverse-buttress screw-threads, as providing ultimate resistance to compressive biting-loads. Hence, although presented herein as an optional feature, we believe our negative/reverse-butress external screw-thread will prove to be an important preventative structural element in better resisting loosening of the primary-implant.

Our primary-implants are preferably made of biocompatible medical-grade/titanium-alloy (superior commercially-pure titanium metal). Recipient's alveoar-bone pilot-hole is conventionally prepared, and our primary-implant experimental embodiment-“a” is installed therein via a special universal/adapter-tool, having an abaxial indexing pin-key arranged to vertically register readily down into a proximally exposed abaxially aligning indexing-hole provided in the uppermost generally radial surface of the primary-implant. The generally quad-shaped female-drive of a conventional dental-wrench hand-tool is fitted with an intermediate driver-tool, which key-pin and alignment-shank are placed into the top of the primary-implant, which is then readily rotated into the alveoar-bone as far as the dental-implant practitioner determines is desirable, owing to the self-tapping screw-thread construction (common to various types of commercially available primary-implants).

Also set forth herein is an alternate generic-variant embodiment-“b” for which we have received FDA-Approval,—and employing a likewise simplified support-system including subordinate components which in this case comprises an asymmetrical male/female like combination of internal abaxial-lobe shaped members joining/indexing positively together.—Thereby like our previously described primary-implant and abutment (embodiment-a), virtually eliminating need for a heretofore required internally-engaging wrenching-tool (ref.: U.S. Pat. Nos. . . . 381 & . . . 079, & . . . 606. With our latter embodiment-b, one or more “lobes” (two opposing lobes thus capable of forming a considered optionally equivalent symmetrically oval-shaped male-into-female design) formed beneath the radial upper body portion of the abutment member (secondary-implant) actually enable the abutment to function as the dentist's installation/extraction device;—therefore, unlike the stated prior-art, only the external top-side utility-stud integral-extension of the abutment-post member itself necessarily employs an optionally square or hexagonal wrench-tool engaging surface. The advantage of this novel configuration resides not only in obviating need for a costly dedicated throw-away tatanium/transfer-tool typically required by the most popular prior-art implant-system (ie—CoreVent®), but the former problematical internal wrench-tool engaging hexagonal (male/hex-tool into internal female/hex-receptacle) surfaces are herein eliminated;—thus essentially negating potential sidewall fractures of the primary-implant. As a precautionary testing-procedure just prior to taking the lab/impression-casting from which the final prosthesis such as a crown is made, and with the secondary-implant (abutment member) tightly secured to the primary-implant, skilled implant-dentists often at their discretion employ a minor re-torquing as a final testing-procedure (thereby basically hand-measuring resistance of the primary-implant to their application of torque), as a way of getting direct feedback “feel” for the potential strength of the implant installation. The dentist generally elects to then leave the primary-implant at its most screwed-in position (rather than subsequently backing-off the rotation, and after a satisfactory site-impression is acquired, the secondary-implant abutment is removed and a temporary capping-screw is installed as usual down into the primary-implant, which keeps it internally clean until the patient returns for installation of the final restorative lab-prosthesis (such as a realistic appearing porcelain-crown).

Accordingly, with either of our generic-variant transfer-systems (embodiments “a” or “b”), if the dentist needs to subsequently back-out the primary-implant slightly (or sometimes all the way), the dentist merely obverses the wrenching-tool, whereby the ratcheting action becomes appropriately reoriented,—as to conversely unscrew the primary-implant. The initially installed primary-implant is preferably externally grit-blasted for permanent bonding of a commercially available HA (hydroxylapatite) bio-reactive substrate coating treatment, preferably extending only proximally near the upper-terminus, thereby leaving a polished-neck uppermost portion found to promote healthy mucosal-tissue interfacing. The once installed primary-implants are thus generally left alone for several months to stabilize during osseointegration (ie—ensconcing, the bone tissue growing intimately to the HA-coating over a period of about 4-6 months);—preceding a subsequent stage-two abutment connection and completion of the cosmetic prosthesis. For purposes of component part relationship clarity, it is also important it be understood that reference herein to terms stating upper or lower for example, are thus supposing exemplified installation of the implant invention oriented down into the recipient's mandibular (jaw)-bone;—while naturally such reference orientation would actually become necessarily inverted when installed upward into one's opposing fixed upper-oral facial maxillary-bone structure. Our primary-implant is thus to be regarded as a general minor-surgery implant in support of virtually any accepted manner of dental-reconstruction;—be it in the form of crown-support, bridge-support, or overdenture-support for edentulous or partially-edentulous recipient patients.

B.) Another object of this invention disclosure is to set forth a dental-implant article according to the preceding embodiment-“a”, wherein is to be provided a cooperative secondary-implant abutment-post member also preferably made of a like inert titanium. This abutment-post is not coated with the HA-substrate, but rather preferably circumferentially tier-grooved and possibly acid-etched or blasted (giving it a microscopic bonding-texture), owing that the second-stage ceramic-crown (fused to internal casting-metal, delivered to the dentist's-clinic from a dental-lab), or other second-stage precious-metal/crown or semi-precious metal-bars or clips (metal attachments) prosthesis portion, is preferably permanently cemented directly atop this secondary-implant. The upper-half of our secondary-implant abutment-post member is generally formed into upward slightly-tapering shape (preferably with slight radial-incuts forming annular radial gripping-grooves, then preferably four fly-cuts are made forming a partial vertical quadranglar/utility-stud finished with a flat-top upper frustum. This preferred combination of abutment-post sculpting (via known CNC-machining) provides a generally universal abutment-post utility-stud configuration, but alternately it can be of other future utility shape as well, making the primary-implant portion ideally suitable as a basic universal anchoring utility implant device. Note that the squared utility-stud portion is preferably made to a ⅛-inch (in USA) nominal size, so as to readily fit standard commonly available dental-implant wrenching-tool design.

In the case of our embodiment-“a”, an abaxial-notch is preferably provided into the otherwise substantially annular albeit preferably frustrum shaped radially-grooved abutment-post (thus absent of the quad-shank fly-cuts), which abaxial-notch likewise registers in precise vertical-alignment (although optionally substantially wider in relief, to afford a convenient interlock-notch for positive anti-twist positioning of the final ceramic-crown for example) with the same former indexing-pin of the adapter-tool used with the dentist's wrenching rachet-tool as stated fro embodiment-“a”. The abutment-post thus optionally employs a downwardly projecting male/screw-threaded shank portion which screws internally into the screw-threaded primary-implant. This novel configuration thus imposes no compromises (ie—internal-hex) to lessen the structural-integrity of the primary-implant's sidewall proximal the internal female/screw-threads, owing to absense of integral coaxial hex/wrenching-surfaces which have been advantageously obviated by use of an abaxial indexing-hole external of the central shaft, facilitating a substantially less structurally invasive pin-key device. Note also, that both of our embodiments “a” and “b” iterations can be made with integral male/screw-threads which enable their respective abutment-posts to be screw directly down into mating female/screw-threads formed into the core-shaft of the primary-implant.

Alternately however, it is provided herein that the abutment-posts not have integral male/screw-threads, instead an assembly/retention-screw in the form of an elongate titanium-shank having male/screw-threads at its lower-terminus acts to cinch the abutment-post tightly down upon the primary-implant as it is screwed into the internal-shaft; this iteration can be in the form of a freely rotatable (prior to cinching action) abutment-post, or in the form of a male/female-indexed abutment-post

C.) Another object of this invention disclosure is to set forth a dental-implant article according to the preceding items-A&B wherein the abutting (interfacing) surfaces of both the primary and secondary implant members are preferably formed with generally non-parallel radial annular-surfaces. These interfacingly opposed annular surfaces are preferably formed with a slight internally-concealed declivity, enabling the very outermost interfacing perimeter portions of the abutting primary and secondary implants to impinge initially, whereupon continued screwing of the two members together forces a mild-sweging action to occur; whereby as the force of their screwing together continues, the entirety of both the adjoining outermost radial-surfaces become intimately impinging in a resultantly hyper-sweged manner abutting against one another. The declivity (preferably approximately 1-5 degrees radial surface disparity, can be provided upon either the top or bottom interfacing radial-surface, or via a matching amount of angular declivity (about 1 to 2½ degrees) formed oppositely into both if preferred;—the primary object being, to create an internal void which becomes enjoined intimately once the abutment-post is ultimately tightened down upon the ensconced primary-implant anchor. The advantage of this TruLock™-abutment configuration residing in its unique ability to more effectively and imperforately seal-off the circular perimeter-edges of the abutting members, with tremendous compressive impingement loading, concentrated where the greatest lateral biting-loads become ultimately directed;—and thereby more effectively sealing the abutment-joint (perimeter circular-region of maximum impingement) from any potential entry of soft-tissue and fluids which heretofore could possibly host bacteria. The primary and secondary adjoining surfaces tending to (in terms of metallurgy) thus essentially “cold-weld” (molecular-fusing) over a period of time, owing the outer perimeter impingement always being compressively-loaded relatively higher than the radially inward annular adjoining abutting-surface portions.

D.) Another object of this invention disclosure is to set forth a dental-implant article according to the preceding items-A&B, wherein the radially abutting (interfacing) surfaces of both the primary and secondary implant members are preferably formed with generally parallel radial annular-surfaces. The radial surface of the primary-implant member is formed radially outward of an inward cavity (inward recess) portion thereto, having a nearly vertical (approximately 2-degrees from vertical) circular sidewall portion. This slightly tapered lower circular-cavity receiving portion is formed concentricly above the primary-implant's female/screw-thread provision, and is designed to intimately interface with a preferably matching degree of tapering male/circular-boss like downward protrusing provided upon the underside of the eventually adjoining abutment-post, formed annular to the downward extending male/screw-threaded shank which enters into the female/screw-threaded hole provided in the primary-implant. This design is critically configured so that as the secondary-implant's (abutment-post) tapered male/circular-boss portion recedes into the primary-implant member, to impinge intimately therewith (somewhat akin to the super friction-lock of a cone-clutch), so do the two interfacing adjoining parallel radial abutment surfaces. Whereupon once so adjoined, the intimately united surfaces of these primary and secondary members become tenaciously wedged intimately together as an alternate TruLock™-abutment provision, creating an internal vertically-tapered joint which is exceptionally resistive to loosening owing to varying chewing-loads. Furthermore, both these item-C and item-D type joint mechanisms can be actually combined if preferred; in as much as they both serve to separately or the once ensconced primary-implant anchoring member.

E.) A further object of this invention disclosure is to set forth a dental-implant article according to the preceding items-A, B, C, D, wherein a special reusable/adapter-tool (non-dispensable) is provided, featuring an abaxial (offset relative to the general longitudinal stacking axis of the primary and secondary component members) indexing pin-key. The tiny indexing pin-key being of an exceptionally high/tensil-strength metal, press-fitted into am abaxial-hole formed into the arbor-plate of the adapter-tool, on a plane precisely parallel to that of the longitudinal stacking-axis of the associated primary and secondary members. Although of ample strength to perform the task of transfering installation or removal rotational torque-loads into the primary and secondary component members, while also providing a convenient offset marker-point by which to accurately reference the number of rotations made into the alveolar-bone by the primary-implant;—if preferred, more than one pin-key (spaced radially apart equidistant from the longitudinal-axis) can be employed in the arbor-plate of the adapter-tool, with a commensurate number of vertically-aligning indexing-holes provided into the primary and secondary implant members.

Another optional feature of this embodiment-“a” type reusable I&R (insertion and retrival) delivery-tool is an abaxial pin-key which is made slightly rotatable upon an eccentric-bushing, whereby mere 90-degree movement of an integrally formed tiny finger-tip operated lever-arm causes the pin-key to bias inward toward the primary-implant's axis, and thereby impose a pinch-binding action of the pin-key within the indexing-hole. Therefore, while in its pinch-binding mode, the I&R/delivery-tool becomes locked fast into the primary-implant (or the type-“a” abutment-post as well), thereby becoming impossible to inadvertently drop (either into the patient's mouth or to the floor) until the locking action of the lever-arm is reversibly released. With this positively engaging I&R-tool the dentist can confidently pull a problem primary-implant outward from a difficult retrival situation.

### DESCRIPTION OF THE PREFERRED EMBODIMENT DRAWINGS

The foregoing and still other objects of this invention will become fully apparent, along with various advantages and features of novelty residing in the present embodiments, from study of the following description of the variant generic species embodiments and study of the ensuing description of these embodiments. Wherein indicia of reference are shown to match related matter stated in the text, as well as the Claims section annexed hereto; and accordingly, a better understanding of the invention and the variant uses is intended, by reference to the drawings, which are considered as primarily exemplary and not to be therefore construed as restrictive in nature; wherein:

FIG. 1A, is a slightly downward looking side-elevation of our embodiment-“a” iteration, shown vertically-stacked in pre-assembly on a longitudinal-axis showing the relationship of the lower primary-implant and upper abutment-post members, and an uppermost installation-tool used to rotatively secure both members as well as serving as a retrival-tool;

FIG. 1B, is an auxiliary plan-view thereof the uppermost embodiment-“a” delivery-tool, showing how the key-pin is preferably held rigidly within a essentric-cam device, so as to thereby become manually biased into a laterally binding pinching action;

FIG. 2A, is a 2×-enlarged side/elevation-view semi/cross-sectional detail thereof, with our embodiment-“a” in initially installed condition, showing how in this iteration a separate delivery-tool is positioned to impingably drive (via phantom outlined std./dental-wrench) the primary-implant into its finally seated position ready for recipient's ensuing osseointegration process;

FIG. 2B, is a subsequent second-stage of our embodiment-“a” installation, here revealing (slightly exaggerated to be clearly demonstrate) a partially installed abutment-post employing HyperSwage™ which feature establishes a unique interstitial annular-declivity void shown here prevailing between the interfacing bottom of the abutment-post and top annular-shoulder of our primary-implant;

FIG. 2C, is a third-stage progression thereof, showing resulting hyper-swaging of their intimately impinging respective perimeters into a substantially prolapsed condition;

FIG. 3A, is a 2×-enlarged side/elevation-view semi/cross-sectional detail thereof, with our embodiment-“B” iteration in initially installed condition, here revealing how the respective vertically mating conical-tapers of our TruLock™-abutment interface prior to being torqued together;

FIG. 3B, is a like view thereof now demonstrating the final intimate mating of our TruLock™-abutment conical-tapers;

FIG. 4A, is a plan-view of our basic dental-implant embodiment-“b” abutment-post, showing the preferred quad-formation of the utility-stud with optionally inset internal-hex provision;

FIG. 4B, is a same scale side/elevation-view thereof, showing how our TruLock™-abutment and HyperSwage™ Perimeter-seal can be compatibly arranged in combination into our basic embodiment-“b” iteration, including a phantom-outline showing how we prefer configuring the utility-stud portion of our abutment-post;

FIG. 4C, is a same scale side/elevation-view thereof, showing the matching embodiment-“b” primary-implant portion, including phantom-outlining showing the mating internal-shaft;

FIG. 5A, is an upper/plan-view of a general assembly retention-screw;

FIG. 5B, is a side/elevation-view thereof showing the general assembly retention-screw for iterations of this grouping;

FIG. 5C, is a side/elevation-view revealing our embodiment-“b” non/screw-threaded abutment-post, having a concentric through-hole by which to facilitate passage of the assembly retention-screw of FIG. 5A;

FIG. 5D, is a general side/elevation-view of our matching embodiment-“b” type primary-implant, which receives the drop-in abutment-post of FIG. 5C;

FIG. 5E, is a 2×-enlarged upper/plan-view showing one iteration of our stress-relieving TorqueLug™ feature, which is characterized as being oval in contour;

FIG. 5F, is an alternate plan-view thereof, revealing an optional symmetrical TorqueLug™ configuration, which is characterized as being lop-eared in contour;

FIG. 5G, is another alternate plan-view thereof, revealing an optional asymmetrical TorqueLug™ configuration, characterized as being oval in contour;

FIG. 5H, is another alternate plan-view thereof, revealing our optional asymmetrical TorqueLug™ configuration, characterized as being U-shaped in contour;

FIG. 6A, is a 4×-enlarged side/elevation-view detail clearly revealing the preferred configuration of our optional major-undercut negative/reverse-buttress, as is generally referenced 6:6 in FIG. 5D;

FIG. 6B, is an 8×-enlarged alternate generic-variant thereof clearly revealing the preferred configuration of our optional minor-undercut negative/reverse-buttress as compared to a horizontal or accute-transverse ref.-line thereto.

### ITEMIZED NOMENCLATURE REFERENCES

10′/10″—primary-implant: embodiment-“a”/embodiment-“b”
11,11′,11″—rigid cylindrical-body, upper-sidewall, mating joint-seam
12—conventional external/screw-threading
13,13′,13″—negative/reverse-buttress screw-thread, superior-surface, rt.-angle ref.-line
14,14′,14″—perimeter radial-shoulder, preimeter-edging, key-pin indexing-hole sidewall
15—TruLock™ female cavity-wall
16,16′—HyperSwage™ declivity-void, divergent-surface
17—TorqueLug™ non-circular indexing-cavity
18,18′—internal-shaft female/screw-threads, pilot-shaft
19,19′—conventional integral/vertical-cutter, lower-terminus
20′/20″—abutment-post: embodiment-“a”/embodiment-“b”
21,21′,21″—basic annular frustum, annular retention-grooves, crest
22,22′,22″—utility-stud, sidewall, indexing notch (embodiment-“a”)
23,23′—abutment-post radial-surface, perimeter-edge
24,24′,24″—downward extending shank, male/screw-threads, upper-boss
25—TruLock™ male-boss cone-face
26—HyperSwage™ optional divergert-surface
27—TorqueLug™ male/indexing-lug
28,28′,28″—assembly retention-screw body, male/screw-threads, allen-head
29—stage-III lab.-produced custom-crown
30,30′,30″,30q—I&R-tool, arbor-plate, pilot-shank, quad-stud (driver)
31,31′,31″—key-pin, eccentric-journal, clincher-arm
32—support-bore
33,33′,33″—longitudinal-axis of: primary implant, abutment-post, I&R-tool
34—conventional quad-drive dental-wrench
35—HA/substrate-coating
36,36′—alveolar-bone, gum-tissue

### DETAILED DESCRIPTION OF THE PREFERRED EMBODIMENTS

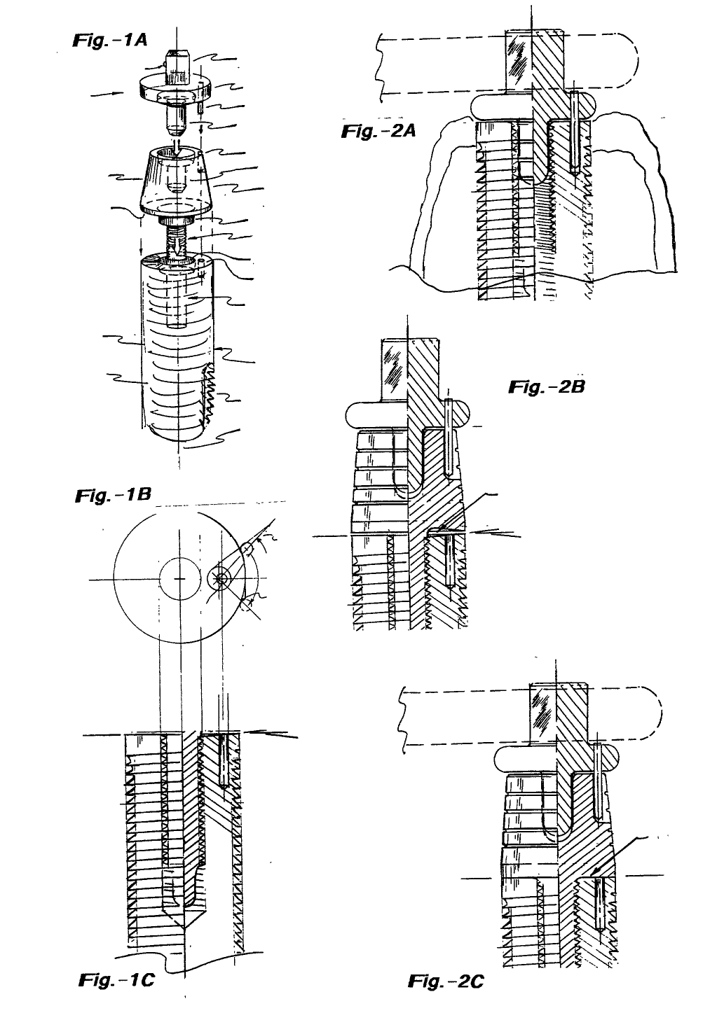

Initial reference is given by way of FIG. 1A wherein is exhibited our embodiment-“a” iteration of this disclosure, which shows a vertically arranged array of cooperating members identified as the primary-implant 10′, and immediately thereabove its screw-in type abutment-post 20′, while poised thereabove a common (applicable to both the primary-implant 10′ and the abutment-post 20′) reusable I&R (insertion & removal)/deliver-tool 30.

In FIG. 1B is shown a plan-view of our I&R-tool 30, wherein is also here included the torque conveying key-pin 31 which is rigidly mounted fixed directly into the arbor-plate 30′ or preferably within a rotatable eccentric-journal 31′ from which extends the finger-tip operated clincher-arm 31″ preferably having a 90-degree swing-arc as indicated. Upon inserting the quad-shank 30q of the I&R-tool 30 into the dentist's existing conventional dental-wrench 34 female-quad receptacle (not shown here), the dentist then proceeds inserting the bifurcated pilot-shank and the abaxially positioned parallel key-pin 31 via the I&R-tool 30 into either the receiving key-pin hole 14″ provided into the radial-shoulder 14 of the primary-implant (or likewise registering index-notch 24 provided on the abutment-post's utility-stud 22), while simultaneously inserting the pilot-shank 30″ into the central receiving-bores XX. In FIG. 1C is shown the manner in which the key-pin 14″ is biased radially inward parallel to the longitudinal-axis 33′ as to thereby very tightly impinge in a pinching manner against the radially inward sidewall 14″ portion of the vertical key-pin hole. It is noted that while this radial or lateral biasing action is rather minute in movement (aprox. 1/32th-inch), it nevertheless is quite powerful in its secure clinching to hold onto either the primary-implant 10′ or the abutment-post 20′.

In FIGS. 2A/B/C are exemplified our embodiment-“a” primary-implant 10′ being screwed securely down into a stage-I pilot-hole the dentist has previously prepared in recipient's surrounding alveolar-bone 36, via the I&R-tool 30 and snap-on dental-wrench 34 (phantom outlined). Note that these necessarily small standard oral/dental-wrenches have a built-in rachet-mechanism, and for sake of compactness are usually simply detached from the quad-stud 30q and merely turned-over upon the quad-stud 30q to resultantly effect an oppositely turning reverse-action. Once procedure of FIG. 5A is completed, a time-period of 4-6 months is generally allowed for osseointegration of the primary-implant's HA/substrate-coating 35 to acquire a reasonable uniting with the alveolar-bone;—at which stage-II the abutment-post 20′ is initially installed for making of the lab-impression from which the lap-technical makes the final crown member 29 (usually outwardly of porcelain). At this stage-II juncture, the dentist also torques the radial-surface 23 of abutment-post 20′ firmly upon the primary-implant 1′/10″, generally tightened nearly to the degree of torque that is to applied during the stage-III final-installation;—thereby assuring proximally the same exact alignment of the impressioned indexing-notch 22″ for example. If as in FIGS. 2B/C the interfacing of the primary-implant's preimeter-shoulder 14 and abutment-post's radial-surface 23 can also employ our preferred HyperSwag™ feature, then procedures are substantially the same;—however it can be seen here in FIG. 2B how a slight declivity void 16 is initially established between the now interfacing bearing-surfaces 16′ (lower) and 26 (upper). In practice, we prefer to locate the radial-taper forming the divergent declivity 16 combined as the perimeter-shoulder 14 of the primary-implant (rather than into the abutment-post underside surface as exemplified in FIG. 2B);—thereby as understood in FIG. 4C, gaining a slight resulting elevation to the polished vertical-perimeter sidewall 11 supporting the outward portion of the declivity (the advantage being that the final imperforate perimeter joint-seam 11″ becomes advantageously located high as possible relative to adjoining sometimes unhealthy gum-tissue 36′). Note that during the final-installation (stage-III), the dentist can optionally at their discretion, insert a tiny-dab of anti-fungal/dental-cement (particular type not shown not given as such bonding-agent formulations improve over time) into the declivity. The abutment-post (be it one of the shown embodiments-“a or b”) is then aggressively torqued from the condition of FIG. 2B into the condition demonstrated in FIG. 2C, whereby the declivity void 16 has essentially dimished into a substantially prolapsed and therey hyper-swaged condition as exemplified in FIG. 2B.

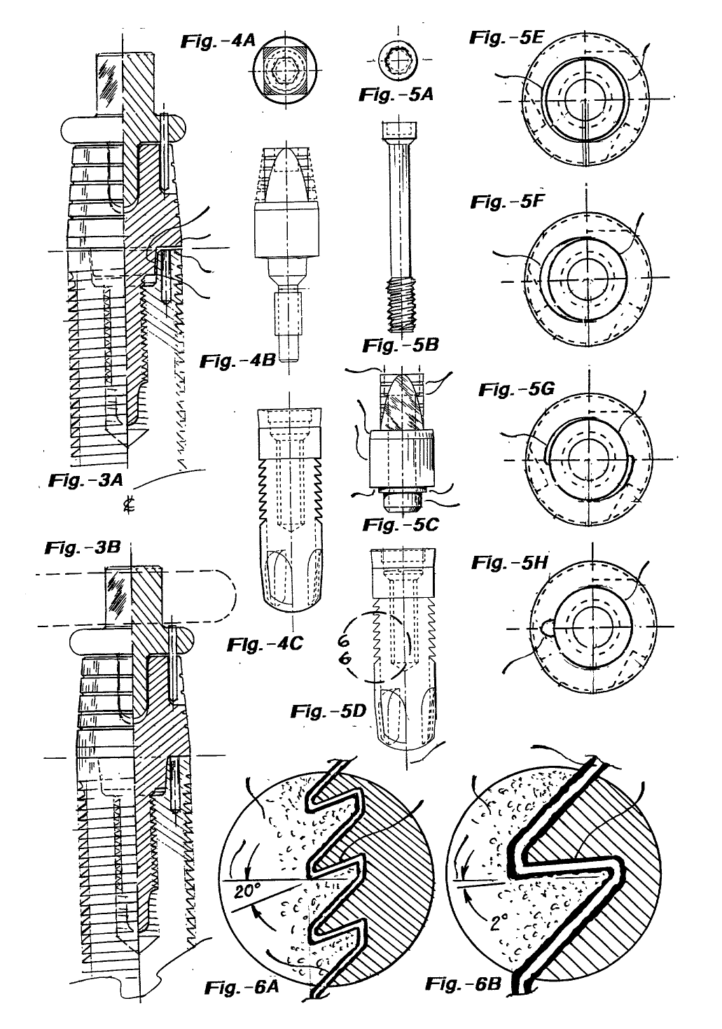

In FIGS. 3A/B is exemplified our cone-clutch like TruLock™ engagement joint simply comprised of two integrally-formed vertically interposing surfaces, the inboard male-boss cone-face 25 and outboard tapered female-cavity cone-face 15, become very intimately joined either by action of the abutment-post's integral utility-stud 22, or by equivalent compression-joining action in the case of alternate assembly-screw 28 technique (in FIG. 5B). It is well known that physical engagement of a cone-clutch has a tremendous locking-action potential;—for example, in very early days of automotive drive-train development, cone-clutches were employed which often grabbed so tenaciously upon engagment that it often became a major-problem for a mechanic to make disengagement. While we presently prefer a steepit narrow taper-angle of approximately only approximately 5-degrees from vertical, this can however as a practical matter range from as little as 2-degrees to as much as 12-degrees in some applications; accordingly, the steeper taper-angle (approaching the vertical) of these respective cone-faces act more efficiently as a locking-device. Moreover, the preferred surface-finish is a lightly grit-blasted one, lending greater grip. Our TruLock™ interlocking-taper device can be employed independently, or in combination with our HyperSwag™ perimeter-sealing feature if so preferred.

There remain subtle, however vital other differences which are to become herein more evident and understood as important improvements. For example, in FIGS. 4A/B/C is exemplified our currently initial FDA-Approved production verison, type embodiment-“b”, here shown employing the TruLock™-device already described in FIGS. 3A/B, and while we prefer employing the well known negative-butress type of external/screw-thread being exemplified here, although most any form of conventional external/screw-thread design will suffice. Note in FIG. 4A how we prefer to first machine the abutment-post frustum XX to an inverted-conical shape, then rotatively machine-in the plural radial-grooves XX which approach proximal the crest 21″ of the frustum; then, transversely fly-cut in the four preferably vertical sidewalls 22′ forming the resultant quad-shaped utility-stud 22 (preferably of standard USA ⅛th-inch size). The male/screw-threads 27′ provided on the downwardly extending shank 27 are thus necessarily formed to a smaller diameter than the optionally tapered upper boss 27″, and in FIG. 4C is shown our presently preferred mating primary-implant configuration whereto a external/screw-thread 12 is shown arranged medially above a state-of-the-art self-drilling flycut-blade(s) 19 arrangement; however, both the screw-threads 12 and vertical flycut-blade(s) 19 can be integrally-formed if preferred as is common practice among commercial dental-implants.

In group FIGS. 5A/B/C/D we show an embodiment-“b” iteration employing a positively-indexing TorqueLug™ feature, which can also be implemented in combination with the affore described HyperSwage™ and TruLock™ provisions. Our TorqueLug™ features an anti-rotation radial-boss like male/indexing-lug portion 27, which drops-in vertically to a precisely mating (slip-fiting) cavity female/indexing-cavity 17 necessarily arranged abaxially to the longitudinal-axis 33′ and within the annular upper-sidewall 11′ (tapered if including TruLock™) of the abutment-post 23. The additional group FIGS. 5E/F/G/H serve to show how the TorqueLug™ male 27 and female 17 portions can be formed to various generic-variant plan-view shapes, all of which essentially perform the same function of attaining both a positive-indexing of the primary-implant 10 and its dependent abutment-post 20′; thereby in some cases enabling the abutment-post's utility-stud 22 to be utilized directly in rotatively installing the primary-implant to via a standard dental-wrench 34.

Lastly, in FIGS. 6A/B, is shown our optional albeit preferred NRB (negative/reverse-buttress) external male/screw-thread configuration, the detail of FIG. 6A includes the exemplified conventional HA-substrate coating 35, and the cross-section serves to clearly demonstrate how the Alveolar-bone 36 is actually caused to be thrust-up for a more positively shored-up supporting of the neg./buttress-thread's superior-surface 13′ here demonstrated at a negative-pitch angle of approximately 20-degrees relative to the accute-angle radial ref.-line 13″ (it being important to note that prior-art conventional reverse-butress screw-threads never exceed the ref.-plane. More restrained implementation of our neg./buttress-thread is taught in adjoining FIG. 6B, whereto a comparatively minor-undercut superior-surface 13′ is demonstrated at a negative-pitch angle of approximately only 2-degrees.

Thus, it is readily understood how the preferred and generic-variant embodiments of of our UNI-PLANT™ dental-implant invention contemplate performing functions in a novel way not heretofore available nor realized. It is implicit that the utility of the foregoing adaptations of this invention are not necessarily dependent upon any prevailing invention patent; and, while the present invention has been well described hereinbefore by way of certain illustrated embodiments, it is to be expected that various changes, alterations, rearrangements, and obvious modifications may be resorted to by those skilled in the art to which it relates, without substantially departing from the implied spirit and scope of the instant invention. Therefore, the invention has been disclosed herein by way of example, and not as imposed limitation, while the appended Claims set out the scope of the invention sought, and are to be construed as broadly as the terminology therein employed permits, reckoning that the invention verily comprehends every use of which it is susceptible. Accordingly, the embodiments of the invention in which an exclusive property or proprietary privilege is claimed, are defined as follows.

What is claimed of proprietary inventive origin is:

1. An endosseous dental-implant of helically-anchoring type providing simplified high-strength construction; said dental-implant comprising:
a primary-implant having a longitudinal-axis and external male/screw-threaded medial portion proximal a lower-terminus means for entering a pilot-hole provided in recipient's alveolar-bone, and including an imperforate sidewall extending from above said medial portion to proximally the opposite upper-terminus thereof where a radial perimeter-shoulder means forms a bearing-surface for laterally stabilized engagement by an interfacing radial-surface of a mating abutment-post means, and including a coaxial longitudinal internal shaft having female/screw-threaded retention means formed down into said upper-terminus, plus an abaxial female/indexing-hole means is formed vertically into said perimeter-shoulder for precise vertical registration with a male/key-pin tool means by which to impart bidirectional rotation, and said abutment-post including an abaxial female/indexing-notch means likewise arranged for precise registration with said male/key-pin tool which can be similarly engaged thereto for tightening/loosening of said abutment-post relative to said primary-implant.

2. The dental-implant apparatus according to claim-1, wherein said perimeter-shoulder is formed radially slightly divergent from said interfacing radial-surface of an adjoining said abutment-post means, said divergence thereby forming a radial declivity there between the two adjoining radial surfaces, assuring that said abutment-post radial-surface outermost perimeter edge impinges initially upon the adjoining outermost edge portion of said perimeter-shoulder, whereupon a slight hyper-sweging deformation condition is induced as the opposed said surfaces become progressively mated according to the cinching torque imposed upon said abutment-post.

3. The hyper-sweging arrangement according to claim-2, wherein said generally radial-surface portion is formed to a positive-chamfer of approximately 1-3 degrees.

4. The hyper-sweging arrangement according to claim-2, wherein said male/key-pin tool includes a longitudinal coaxial pilot-lug and a key-pin means rotatable within an eccentric-bore via a leverarm, said key-pin thereby exerting a lateral pinching action.

5. The dental-implant apparatus according to claim-1, wherein said perimeter-shoulder is formed annular to a tapering circular-cavity portion formed concentricly above said female/screw-threads, the taper of said female/circular-cavity being formed to interface with an adjoining tapering male/circular-boss portion formed upon the underside of said secondary abutment member means, said tapering surfaces merging intimately to attain a super friction-lock of said abutment member means down upon said adjoining primary implant as the opposed said surfaces become progressively tenacious according to the degree of tightness imposed upon one another; thereby creating a joint exceptionally resistive to loosening.

6. The frictional interlocking arrangement according to claim-5, wherein said taper is approximately 1-5 degrees.

7. The dental-implant apparatus according to claim-1, wherein said male/screw-threading is of an undercut negative/buttress-thread configuration, thereby presenting a shore-stabilized screw-thread surface-area ultimately resistant to compressive biting-loads.

8. An endosseous dental-implant of helically-anchoring type providing simplified high-strength construction; said dental-implant comprising:
a primary-implant having a longitudinal-axis and external male/screw-threaded medial portion proximal a lower-terminus means for entering a pilot-hole provided in recipient's alveolar-bone, and including an imperforate sidewall extending from above said medial portion to proximally the opposite upper-terminus thereof where a radial perimeter-shoulder means forms a bearing-surface for laterally stabilizing engagement by the interfacing radial-surface of a separable abutment-post means, said primary-implant including a coaxial longitudinal internal shaft having female/screw-threaded retention means formed down into said upper-terminus, including an abaxial female/indexing-void means formed internally below proximal said perimeter-shoulder for receiving vertical downward precise registration of a mating male/indexing-lug means provided upon underside of separate said abutment-post means, thus placing said abutment-post in fixed orientation to said primary-implant and able to thereby convey bidirectional rotational-torque upon said primary-implant via application of a standard dental-wrench to utility-stud; plus, a coaxial retention-screw is finally installed into said female/screw-threads locking said abutment-post down intimately indexed upon said primary-implant.

9. The hyper-sweging arrangement according to claim-8, wherein said perimeter-shoulder is formed radially slightly divergent from said interfacing radial-surface of an adjoining said abutment-post means, said divergence thereby forming a radial declivity there between the two adjoining radial surfaces, assuring that said abutment-post radial-surface outermost perimeter edge impinges initially upon the adjoining outermost edge portion of said perimeter-shoulder, whereupon a slight hyper-sweging deformation condition is induced as the opposed said surfaces become progressively mated according to the cinching torque imposed upon said abutment-post for a critically imperforate perimeter joint-seam.

10. The hyper-sweging arrangement according to claim-9, wherein said generally radial-surface portion is formed to a positive-chamfer of approximately 1-3 degrees.

11. The hyper-sweging arrangement according to claim-9, wherein generally circular said perimeter-shoulder portion is formed to a positive-chamfer of approximately 1-3 degrees, thereby helping elevate the perimeter-joint above recipients alveolar-bone.

12. The dental-implant apparatus according to claim-9, wherein said perimeter-shoulder is formed annular to a tapering circular-cavity portion formed concentricly above said female/screw-threads, the taper of said female/circular-cavity being formed to interface with an adjoining tapering male/circular-boss portion formed upon the underside of said secondary abutment member means, said tapering surfaces merging intimately to attain a super friction-lock of said abutment member means down upon said adjoining primary implant as the opposed said surfaces become progressively tenacious according to the degree of tightness imposed upon one another; thereby creating a joint exceptionally resistive to loosening.

13. The frictional interlocking arrangement according to claim-12, wherein said taper is approximately 1-5 degrees.

14. The dental-implant apparatus according to claim-8, wherein said male/screw-threading is of an undercut negative/buttress-thread configuration, thereby presenting a shore-stabilized screw-thread surface-area ultimately resistant to compressive biting-loads.

15. The dental-implant apparatus according to claim-8, wherein said abutment-post includes an upward extending quad-shaped utility-stud.

16. The dental-implant apparatus according to claim-8, wherein said abaxial female/indexing-void means and said abaxial male/indexing-lug portions can be formed to a symmetrically balanced stress-relieved 180-degree opposed oval-shaped mating cross-section.

17. An endosseous dental-implant of helically-anchoring type providing simplified high-strength construction; said dental-implant comprising:
a primary-implant having a longitudinal-axis and external male/screw-threaded medial portion proximal a lower-terminus means for entering a pilot-hole provided in recipient's alveolar-bone, and including an imperforate sidewall extending from above said medial portion to proximally the opposite upper-terminus thereof where a radial perimeter-shoulder means forms a bearing-surface for laterally stabilizing engagement by an interfacing radial-surface of a separable abutment-post means, said perimeter-shoulder formed radially slightly divergent from said interfacing radial-surface of adjoining said abutment-post means, said divergence thereby forming a radial declivity there between the two adjoining radial surfaces, assuring that said abutment-post radial-surface outermost perimeter edge impinges initially upon the adjoining outermost edge portion of said perimeter-shoulder, whereupon a slight hyper-sweging deformation condition is induced as the opposed said surfaces become progressively mated according to the cinching torque imposed by said abutment-post; thereby creating a critically imperforate perimeter joint-seam, and said primary-implant including a coaxial longitudinal internal shaft having female/screw-threaded retention means formed down into said upper-terminus whereby a male/screw-threaded integral shank extending from underside of said abutment-post enables said abutment-post is secured therein via application of a separate standard dental-wrench to utility-stud of said abutment-post, thereby finally engaging said radial-surface tightly down upon said perimeter-shoulder.

18. The dental-implant apparatus according to claim-17, wherein said perimeter-shoulder is formed annular to a tapering circular-cavity portion formed concentricly above said female/screw-threads, the taper of said female/circular-cavity being formed to interface with an adjoining tapering male/circular-boss portion formed upon the underside of said secondary abutment member means, said tapering surfaces merging intimately to attain a super friction-lock of said abutment member means down upon said adjoining primary implant as the opposed said surfaces become progressively tenacious according to the degree of tightness imposed upon one another; thereby creating a joint exceptionally resistive to loosening.

19. The hyper-sweging arrangement according to claim-18, wherein said generally radial-surface portion is formed to a positive-chamfer of approximately 1-3 degrees.

20. The hyper-sweging arrangement according to claim-18, wherein generally circular said perimeter-shoulder portion is formed to a positive-chamfer of approximately 1-3 degrees, thereby helping to elevate the perimeter-joint above recipients alveolar-bone.
